(19) United States
(12) Patent Application Publication
(10) Pub. No.: US 2006/0196853 A1
(43) Pub. Date: Sep. 7, 2006

(54) Micro-joining using electron beams

(75) Inventors: John W. Elmer, Danville, CA (US); Todd A. Palmer, Livermore, CA (US); Alan T. Teruya, Livermore, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/173,849

(22) Filed: Jun. 30, 2005

Related U.S. Application Data
(60) Provisional application No. 60/658,668, filed on Mar. 4, 2005.

(51) Int. Cl. B23K 15/02

(52) U.S. Cl. 219/121.12

(57) ABSTRACT

A low power electron beam system can be utilized for micro welding, brazing, or heating a workpiece and as an imaging system for precise positioning of a micro electron beam with regard to a workpiece. A filament system produces a micro electron beam, which is then focused onto the workpiece. In the welding mode, the micro electron beam is used to melt the workpiece and produce a weld. When switched to the imaging mode, the backscattered or secondary electrons produced by the interaction between the micro electron beam and the work piece are captured and converted into an image of the workpiece. The resulting image formed from these captured electrons is used as an aid in the precise positioning of the micro electron beam and inspection of the workpiece.

### CROSS-REFERENCE TO RELATED APPLICATIONS

This application claims the benefit of U.S. Provisional Patent Application No. 60/658,668 titled “Micro-Joining Using Electron Beams” filed Mar. 4, 2005 by John W. Elmer, Todd A. Palmer, and Alan T. Teruya. U.S. Provisional Patent Application No. 60/658,668 filed Mar. 4, 2005 is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to electron beams and more particularly to a system using an electron beam for welding, brazing, and/or heating.

2. State of Technology

U.S. Pat. No. 6,646,222 issued Nov. 11, 2003 to Richard Ray Burlingame for an electron beam welding method provides the following state of technology information: In an electron beam welding process a concentrated stream of high-energy electrons is directed to the abutting surfaces or interface of the work pieces to be welded. This high-energy electron bombardment causes rapid heating, forming a vapor hole surrounded by molten metal. The work piece is then moved away from the beam. The molten metal flows away from the hole and solidifies to form the weld. This technique is highly satisfactory for welding relatively thin pieces of metal together. The process is also used to weld large structural members. In general, an electron beam welding apparatus is provided with an electron gun and a driving table disposed in a vacuum chamber. The electron gun emits an electron beam which is directed on an interface between the two work pieces that melts and welds the metals at the abutment.

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides (1) an electron beam apparatus that can be utilized for welding, brazing, or heating a workpiece and (2) an imaging system. Unlike existing electron beam welding systems, this apparatus is used to join workpieces which are typically on the scale of 1 mm and less in size. In order to precisely position the electron beam on a work piece of this size, an integrated imaging system, which utilizes the same electron beam components used to join the workpieces, is required.

The present invention provides a new type of electron beam welder for low power micro electron beams for micro joining applications. In the welding mode, the micro electron beam is characterized by a rather large accelerating voltage in the range of 30 kV and higher and rather low beam currents in the range of 100 μA. The beam is then focused and directed onto the workpiece, causing almost instantaneous local melting and vaporization of the workpiece material and producing a weld. The present invention can also be used as a more generalized heat source for performing micro brazing, as a defocused micro heat source for localized heat treating, and as a high intensity heat source for micro-hole drilling and cutting applications.

Before and after welding, the apparatus can be converted from the welding mode to an imaging mode. In this imaging mode, the electron beam, which is typically set at a lower accelerating voltage and beam current than that used in the welding mode, is rapidly deflected or rastered over the area of interest. The secondary or backscattered electrons produced by the interaction between the beam and the surface of the workpiece are then captured by detectors placed in the work chamber and converted into an image using electronic components typical of those used in Scanning Electron Microscopes (SEM).

The present invention has uses as a welder for microsensors, target capsules, enhanced biomedical devices, micro electro-mechanical system components, and devices. Applications include the fabrication of complex Micro-Electro-Mechanical Systems (MEMS) and microelectronics, the repair of advanced extreme ultraviolet lithography (EUVL) photolithography masks, and the fabrication of National Ignition Facility (NIF) targets.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 is an illustration of an electron beam welding system that enables small components to be welded, brazed and/or locally heat treated at previously unobtainable size scales.

FIG. 2 is an illustration showing the electron beam welding system being used in the imaging mode functioning as a scanning electron microscope to align components prior to joining or to inspect the completed joints.

FIG. 3 is an illustration showing the electron beam welding system being used in the welding, brazing, heating mode functioning as an electron beam welding system used to weld, braze and/or locally heat small components.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

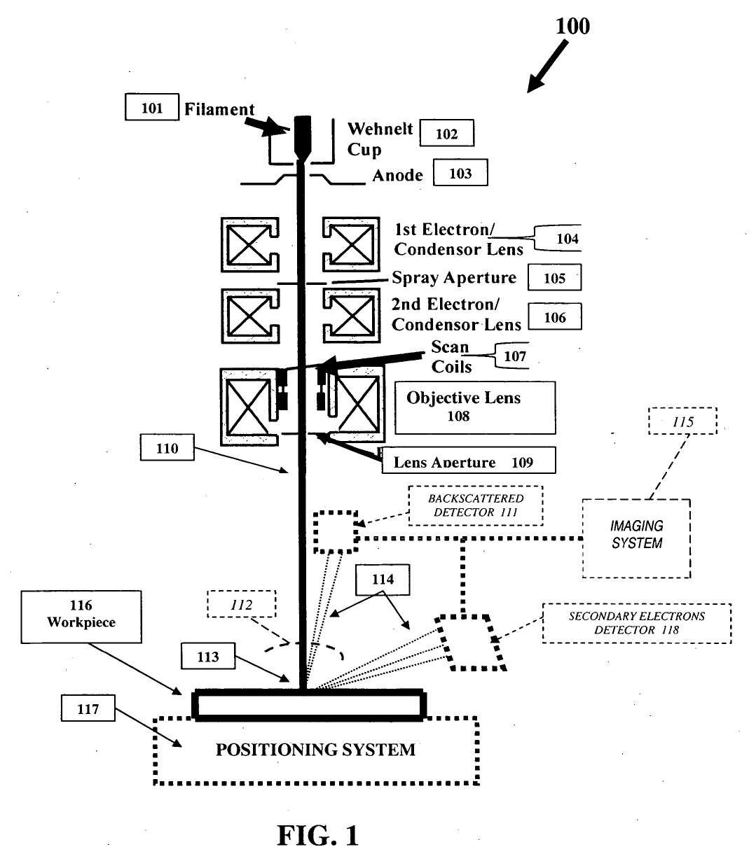

Referring now to the drawings and in particular to FIG. 1, an embodiment of an electron beam welding system incorporating the present invention is illustrated. The electron beam welding system is designated generally by the reference numeral 100. The development of the electron beam welding system 100 enables small components to be welded, brazed and/or locally heated at previously unobtainable size scales.

Technological advancements are requiring components to be designed and fabricated with increasingly smaller dimensions in many fields. With this reduction in size there is a continuing need to refine conventional welding/joining methods to be able to assemble and fabricate devices on these smaller scales. Lasers, with their high power densities and ability to focus their energy to small spot sizes, have been used for many years to join small components. However, there are inherent limitations in the focusing ability of lasers, thus limiting the smallest spot size to several times their wavelength. In addition, lasers do not couple well with highly reflective materials such as gold, copper and silver which are often used to fabricate small scale components, and they tend to reflect off of curved surfaces.

Electron beams on the other hand can be focused to much smaller spot sizes than lasers, as evidenced by the nano-sized beams routinely produced in scanning and transmission microscopy, and in electron beam lithography. These high energy electron beams (>10 keV) also couple well with all electrically conductive materials.

Existing electron beam welders are not suited to operations at micro-scale resolutions. It is thus necessary to make modifications to these existing systems. The electron beam welding system 100 is designed to produce low power electron beams for use in micro joining applications. The electron beam welding system 100 also has a built-in imaging capability, with which the workpiece can be observed both prior to and after welding; thus, allowing the joint alignment to be inspected. The electron beam welding system 100 can also be used as a more generalized heat source for performing micro brazing, as a defocused micro heat source for localized heat treating, and as a high intensity heat source for micro hole drilling and cutting applications.

The electron beam welding system 100 includes the following structural components: filament 101, Wehnelt Cup 102, anode 103, 1^{st} electron/condenser lens 104, spray aperture 105, 2^{nd} electron/condenser lens 106, scan coils 107, objective lens 108, lens aperture 109, and positioning system 117. The electron beam welding system 100 also includes conventional components of electron beam welders, including a high voltage power source, vacuum chamber or enclosure, pumping equipment and control systems.

For illustration purposes, the components of the system used in the imaging mode are shown in FIG. 1 in phantom. In order to switch between the welding mode and imaging mode, the deflection/scan coils 107 in the electron beam column are respectively disabled or enabled. When the system is in the welding mode, the current required in the beam 110 is much higher than that needed for the imaging mode. In addition, when the system is in the imaging mode, the beam is deflected or rastered over a selected region as indicated by the dashed line 112, depending on the desired magnification of the image to be viewed. As part of the imaging system, a secondary electron 115 and/or backscattered electron 111 detectors are positioned to capture the electrons formed by the interaction between the electron beam and the workpiece. An imaging system 115 is connected to both detectors in order to convert the captured electrons into an image of the workpiece 117.

The structural components of the electron beam welding system 100 having been described and illustrated in FIG. 1, the construction and operation of the electron beam welding system 100 will now be considered. The electron beam welding system 100 utilizes a fusion process for joining metals using a highly focused beam of electrons as a heat source. In the electron beam welding system 100, electrons are extracted from the filament 101, accelerated by the high potential beam accelerating voltage, and magnetically focused into the spot 113 on the workpiece. This causes almost instantaneous local melting and vaporization of the workpiece material at the spot 113. The pumping equipment and control systems are utilized to maintain the system in a vacuum with the vacuum chamber or enclosure.

The electron beam welding system 100 has uses as a welder for microsensors, target capsules, enhanced biomedical devices, and micro electro-mechanical system components. For example, specific applications include the fabrication of complex Micro-Electro-Mechanical Systems (MEMS) and microelectronics, the repair of advanced extreme ultraviolet lithography (EUVL) photolithography masks, and the fabrication of units for the National Ignition Facility (NIF) targets.

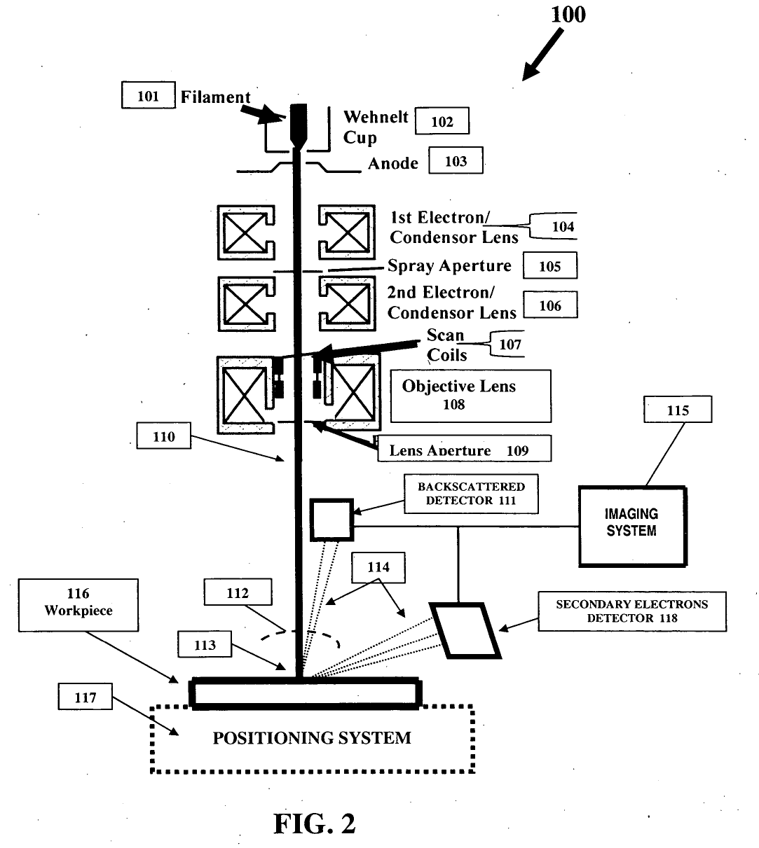

Referring now to FIG. 2, an illustration shows the electron beam welding system 100 being used in the imaging mode. While in the imaging mode, the electron beam welding system 100 basically functions as a scanning electron microscope. In this mode, the workpiece is imaged, allowing the alignment of the workpiece components to be verified both prior to and after the completion of the welding or joining operation. When the system 100 is in the imaging mode, the beam 110 is deflected or rastered over a selected region, depending on the desired magnification of the image to be viewed. This requires that the deflection/scan coils 107 be made operable.

In the imaging mode electrons are extracted from the hot cathode filament 101 of the Wehnelt Cup 102 to produce the electron beam 110. The electron beam is directed to the anode 103, to the 1^{st} electron/condenser lens 104, to the spray aperture 105, to the 2^{nd} electron/condenser lens 106, to the scan coils 107, to the objective lens 108, and to the lens aperture 109. The electron beam 110 is focused on the workpiece 116.

Secondary electrons or backscattered electrons 114 are captured and converted into an image of the workpiece 116. The beam 110 is shown rastering over an area of the work piece as indicated at 112. Electrons 114 coming off the workpiece 116 at an angle are received by the secondary electron detector 115. Other electrons 114 reflecting back in the direction of the beam 110 are captured by the backscattered electron detector 111. These signals are then transmitted to the imaging system 115 and converted into an image of the workpiece.

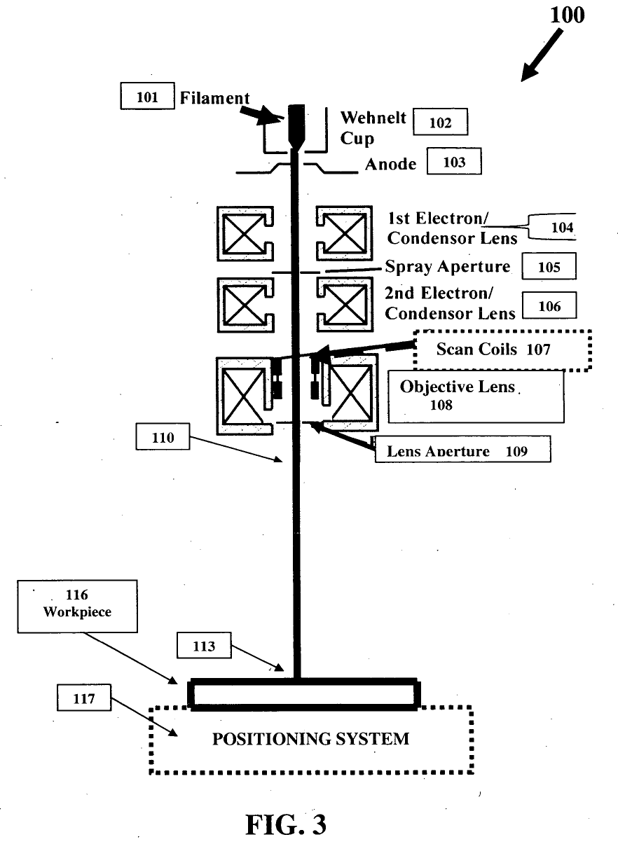

Referring now to FIG. 3, an illustration shows the electron beam welding system 100 being used in the welding mode. In this mode, the electron beam welding system 100 functions as an electron beam welding system and can be used to weld, braze and/or locally heat small components. In this mode, electrons are extracted from the filament 101 of the Wehnelt Cup 102 to produce the electron beam 110. The electron beam is directed to the anode 103, to the 1^{st} electron/condenser lens 104, to the spray aperture 105, to the 2^{nd} electron/condenser lens 106, to the scan coils 107, to the objective lens 108, to the lens aperture 109, and focused onto the spot 113 on the workpiece 116.

When the system 100 is in the welding mode, the current required in the beam 110 is much higher than that needed for the imaging mode. In addition, in the welding mode, the deflection/scan coils 107 are rendered inoperable, and the beam 110 follows a straight line path from the column to the workpiece 116.

The electron beam welding system 100 has the ability to generate a 30 kV electron beam with a 100 μA current. Power densities greater than 1 kW/mm² are achievable in micron diameter beams. Sufficient power densities are obtained from the electron beam welding system 100 to melt and join materials.

The present invention has uses as a welder for microsensors, target capsules, enhanced biomedical devices, micro electro-mechanical system components, and devices. Applications include the fabrication of complex Micro-Electro-Mechanical Systems (MEMS) and microelectronics, the repair of advanced extreme ultraviolet lithography (EUVL) photolithography masks, and the fabrication of National Ignition Facility (NIF) targets.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is

1. An electron beam apparatus for welding, brazing, or heating a workpiece in a welding, brazing or heating mode and for imaging the workpiece in an imaging mode using electrons produced by the interaction between the beam and the workpiece, comprising:
an electron beam source that produces an electron beam,
a positioner for positioning the workpiece relative to said electron beam,
a selectively operated system for rastering said electron beam relative to the workpiece, and
a selectively operated imaging system,
wherein, when said apparatus is in the welding mode said electron beam is directed onto the workpiece for welding, brazing, or heating, and
wherein, when said apparatus is in the imaging mode said electron beam is rastered relative to the workpiece and said imaging system captures the electrons produced by the interaction between the beam and the workpiece to provide an image of the workpiece.

2. The electron beam apparatus of claim 1 wherein said imaging system captures secondary electrons.

3. The electron beam apparatus of claim 1 wherein said imaging system captures backscattered electrons.

4. The electron beam apparatus of claim 1 wherein said imaging system captures secondary electrons and backscattered electrons.

5. The electron beam apparatus of claim 1 wherein said imaging system is located in an operative position relative to the workpiece, wherein said electron beam strikes the workpiece producing both backscattered and secondary electrons which are then captured and used to produce said image of the workpiece, and wherein said positioner provides precise positioning of the workpiece relative to said electron beam.

6. The electron beam apparatus of claim 1 wherein said electron beam source produces a micro electron beam.

7. The electron beam apparatus of claim 6 wherein said micro electron beam comprises a substantially 30 kV electron beam with a substantially 100 μA current.

8. An electron beam apparatus for welding, brazing, or heating a workpiece in a welding, brazing or heating mode and for imaging the workpiece in an imaging mode using electrons produced by the interaction between the beam and the workpiece, comprising:
electron beam means for producing an electron beam and directing said electron beam to the workpiece,
positioning means for positioning the workpiece relative to said electron beam,
selectively operated rastering means for rastering said electron relative to the workpiece, and
selectively operated imagining means for imaging the workpiece,
wherein, when said apparatus is in the welding, brazing or heating mode said electron beam is directed onto the workpiece for welding, brazing, or heating, and
wherein, when said apparatus is in the imaging mode said electron beam is rastered relative to the workpiece and said imaging system captures electrons produced by the interaction between the beam and the workpiece to provide an image of the workpiece.

9. The electron beam apparatus of claim 8 wherein said imaging means captures secondary electrons.

10. The electron beam apparatus of claim 8 wherein said imaging means captures backscattered electrons.

11. The electron beam apparatus of claim 8 wherein said imaging means captures secondary electrons and backscattered electrons.

12. The electron beam apparatus of claim 8 wherein said imaging means is located in an operative position relative to the workpiece wherein said electron beam strikes the workpiece, producing both backscattered and secondary electrons which are then captured and used to produce said image of the workpiece, allowing for the precise positioning of said electron beam with regard to the workpiece.

13. The electron beam apparatus of claim 8 wherein said electron beam means for producing an electron beam produces a micro electron beam.

14. The electron beam apparatus of claim 13 wherein said micro electron beam comprises a substantially 30 kV electron beam with a substantially 100 μA current.

15. A method of electron beam welding, brazing, or heating a workpiece comprising the steps of:
producing an electron beam,
placing an imaging system in operative position to the workpiece,
focusing said electron beam on the workpiece and reflecting at least a portion of said electron beam to said imaging system to provide imaging information,
using said imaging information to provide precise positioning of the electron beam with regard to the workpiece, and
using said electron beam for welding, brazing, or heating said workpiece.

16. The method of electron beam welding, brazing, or heating of claim 15 wherein said step of reflecting at least a portion of said electron beam to said imaging system comprises reflecting secondary electrons.

17. The method of electron beam welding, brazing, or heating of claim 15 wherein said step of reflecting at least a portion of said electron beam to said imaging system comprises reflecting backscattered electrons.

18. The method of electron beam welding, brazing, or heating of claim 15 wherein said step of reflecting at least a portion of said electron beam to said imaging system comprises reflecting secondary electrons and backscattered electrons.

19. The method of electron beam welding, brazing, or heating of claim 15 wherein said step of producing an electron beam produces a micro electron beam.

20. The method of electron beam welding, brazing, or heating of claim 15 wherein said step of producing an electron beam produces a substantially 30 kV micro electron beam with a substantially 100 μA current.
